(19) United States
(12) Patent Application Publication
(10) Pub. No.: US 2016/0164828 A1
(43) Pub. Date: Jun. 9, 2016

(54) ADJUSTING VIRTUAL MACHINE RESOURCES

(71) Applicant: HANGZHOU H3C TECHNOLOGIES CO., LTD., Hangzhou City (CN)

(72) Inventor: Songer SUN, Beijing (CN)

(73) Assignee: Hangzhou H3C Technologies Co., Ltd., Hangzhou City (CN)

(21) Appl. No.: 14/899,792

(22) PCT Filed: Aug. 22, 2014
(86) PCT No.: PCT/CN2014/085001

§ 371 Date: Dec. 18, 2015

(30) Foreign Application Priority Data
Aug. 28, 2013 (CN) 201310379991.4

(51) Int. Cl. H04L 29/12; G06F 9/455

(52) U.S. Cl. CPC H04L 61/2007; G06F 9/45558; G06F 2009/45595; H04L 61/6068

(57) ABSTRACT

In an example of the present disclosure, a method for adjusting virtual machine resources is provided. A VIP for a virtual service is distributed, and a scheduling policy and virtual machines (VM) for the VIP may be configured. The VIP and the VMs corresponding to the VIP are configured on an underlying physical device. When status information of the VIP is received, a new VM may be added into the VMs corresponding to the VIP in response to the determination that the VIP is overloaded based on the status information of the VIP. The scheduling policy of the VIP may be used to distribute bearer services to the VMs corresponding to the VIP.

### BACKGROUND

When a data center of an enterprise is in the process of changing to cloud computing, it may realize server virtualization to increase server efficiency. Meanwhile, an IT management department of the enterprise usually deploys load balancing (LB) systems to be placed ahead of virtual machine resource pools, in order to fulfill the requirements regarding operational reliability and performance for certain services. Through the LB systems, access scheduling is carried out for virtual machine resources. During the process, the server virtualization and the LB system deployment are independent of each other.

### BRIEF DESCRIPTION OF THE DRAWINGS

For a better understanding of the present disclosure, reference should be made to the Detailed Description below, in conjunction with the following drawings in which like reference numerals refer to corresponding parts throughout the figures.

FIG. 1 is a flowchart illustrating a method for adjusting virtual machine resources in an example of the present disclosure.

FIG. 2(a) is a flowchart of a method for adjusting virtual machine resources in an example of the present disclosure.

FIG. 2(b) is a flowchart of an interaction process for adjusting virtual machine resources in an example of the present disclosure.

FIG. 3(a) is a block diagram of an LB system including an LB management device and an LB forwarding device in accordance with an example of the present disclosure.

FIG. 3(b) is a block diagram of a network communications system in accordance with an example of the present disclosure.

FIG. 4 is a flowchart of a method for determining whether a VIP overload exists in an example of the present disclosure.

FIG. 5 is a schematic diagram illustrating the structure of a device in an example of the present disclosure.

FIG. 6 is a schematic diagram of the hardware structure of a device in an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

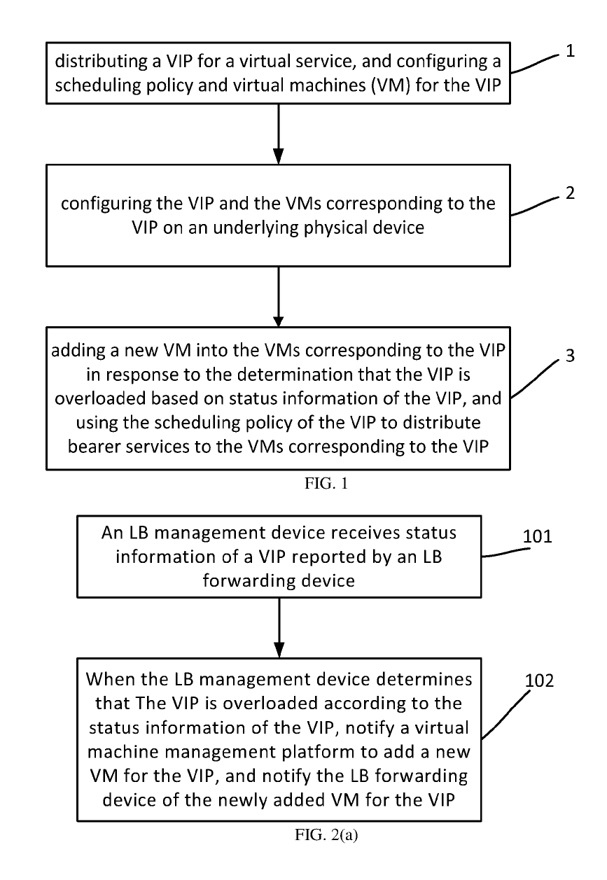

In an example of the present disclosure, a method for adjusting resources of virtual machines is as shown in FIG. 1, which may be implemented using a computing device. At Block 1, allocate virtual IP addresses (VIP) for virtual services, and configure a scheduling policy and corresponding virtual machines (VM) for a VIP. At Block 2, configure the VIP and the VMs corresponding to the VIP on an underlying physical device. At Block 3, when status information of the VIP is received, determine whether the VIP is overloaded based on the status information of the VIP. A new VM may be added for the VIP when it is determined that the VIP is overloaded. The scheduling policy of the VIP may be used to distribute bearer services to the VMs corresponding to the VIP. In an example, the underlying physical device may be a load balanced device, or it may be another network hardware device with load balancing capabilities. For example, the underlying physical device may be a firewall that possesses load balancing capabilities, etc.

In an example, the method illustrated in FIG. 1 may be implemented on an LB management device. The LB management device may receive status information for virtual IP addresses detected and reported by an LB forwarding device. When it is determined that a virtual service corresponding to a VIP is overloaded based on the status information of the VIP, notify a virtual machine management platform to add new virtual machines for the VIP. The LB forwarding device may also be notified of the newly added VMs of the VIP. The LB forwarding device may use the scheduling policy of the VIP issued by the LB management device to distribute bearer services to the VMs corresponding to the VIP, including the newly added VMs. In this way, the LB system may have the capability to automatically implement dynamic adjustment of resources for virtual machines, thereby reducing the operation and maintenance workload.

In an example, the LB management device may divide virtual services based on service conditions, allocate a VIP for a virtual service, configure a scheduling policy as well as corresponding VMs for the VIP, and issue the configured information to the LB forwarding device. The LB forwarding device may configure the VIP as well as the VMs corresponding to the VIP on the underlying physical device. In an example, the VIP may be an IP address used to access the corresponding virtual service. That is, the VIP may be used to refer to the virtual service.

In an example, it is supposed that N number of VIPs may be allocated based on service conditions, which are VIP1 to VIPN. VIP1 and VIP2 may be illustrated as examples. As to VIP1, 5 IP addresses may be allocated for VIP1, such as IP1 to IP5. That is, 5 virtual machine resources from IP1 through IP5 are predefined for VIP1 for bearing services. As to VIP2, 11 IP addresses may be allocated for VIP2, such as IP10 to IP20. That is, 11 virtual machine resources from IP10 through IP20 are predefined for VIP2 for bearing services.

In an example, a certain range of IP addresses may be reserved for VIP1, such as IP6 through IP9. When VIP1 is overloaded in the follow up, the reserved IP addresses may be used as IP addresses of VMs newly added to VIP1. This may guarantee the continuity of IP addresses, and provide easy access and management. In an example, IP addresses that have not been used in another VIP may be allocated for the newly added VMs for VIP1. Similar processing may be carried out to VIP2 to VIPN.

The LB management device may configure a scheduling policy for a VIP, and then send it to the LB forwarding device. In an example, an API may be configured, and the configured information may be issued and invoked through the API.

Based on the configured information of the VIP and the corresponding VMs issued by the LB management device, the LB forwarding device may configure the VIP and corresponding VMs on an underlying physical device. The LB forwarding device may also record the scheduling policy of the VIP issued by the LB management device. The scheduling policy may be used to implement load balancing for service distribution between the VMs corresponding to the VIP.

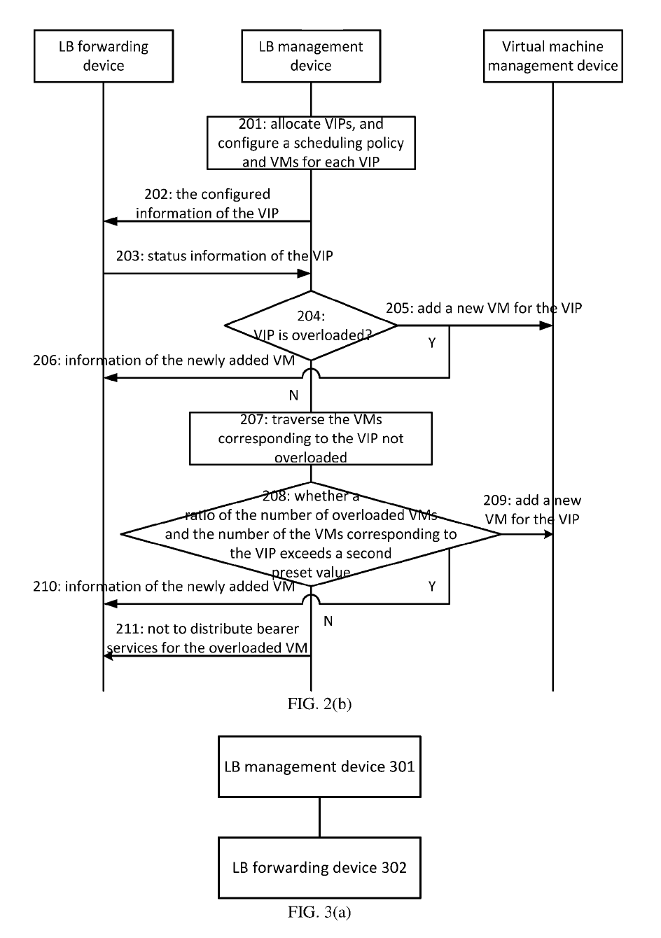

FIG. 2(a) is a flow chart of a method for adjusting virtual machine resources in an example of the present disclosure.

At Block 101, an LB management device receives status information of a VIP detected and reported by an LB forwarding device.

The LB forwarding device may automatically detect application status of the VIP, make a statistics on status information of the VIP, and report it to the LB management device.

In an example, the status information of the VIP may include: a current flow rate of the VIP, a current number of concurrent connections of the VIP, and a current number of requests per second of the VIP.

At Block 102, if the LB management device determines that the VIP is overloaded based on the status information of the VIP, the LB management device may notify a virtual machine management platform to add a new VM for the VIP, and notify the LB forwarding device that a new VM was added for the VIP, causing the LB forwarding device to use the scheduling policy of the VIP issued by the LB management device for distributing bearer services for the VMs corresponding to the VIP.

In this Block, when the LB management device notifies the virtual machine management platform to add a new VM, the virtual machine management platform is simultaneously notified of the IP address for the newly added VM. In an example, the IP address may be an IP address reserved for the VIP.

When the LB management device allocates VIPs, it may configure the maximum bandwidth, the maximum number of concurrent connections, and the maximum number of requests for each VIP. Moreover, it may configure a first preset value to be used as parameters to determine if the VIP is overloaded.

In an example, the method for the LB management device to determine whether a VIP is overloaded may be as follows.

1. Determine a ratio of the flow rate of the VIP, a ratio of the number of concurrent connections of the VIP, and a ratio of the number of requests of the VIP.

In an example, the ratio of the flow rate of the VIP may be a ratio between a current flow rate of the VIP and the maximum bandwidth of the VIP. The ratio of the number of concurrent connections of the VIP may be a ratio between a current number of concurrent connections of the VIP and the maximum number of concurrent connections of the VIP. The ratio of the number of requests of the VIP may be a ratio between a current number of requests per second of the VIP and the maximum number of requests of the VIP.

2. Determine an overload index of the VIP.

In an example, calculate a weighted sum of the ratio of the flow rate of the VIP, the ratio of the number of concurrent connections of the VIP, and the ratio of the number of requests of the VIP to obtain the overload index of the VIP. In an example, a parameter not required to participate on the weighted calculation may be set as 0. For example, if the ratio of the flow rate of the VIP is not required, its weight may be set as 0. In another example, the overload index of the VIP may be defined under practical requirements.

3. Determine if the overload index of the VIP exceeds the first preset value, if it does, determine that the VIP is overloaded; if not, determine that the VIP is not overloaded.

In an example, when the VIP is not overloaded, the running status of the VMs corresponding to the VIP may be determined. For example, whether there are overloaded VMs, and how many VMs are overloaded, etc., may be determined.

If it is determined that the VIP is not overloaded based on the status information of the VIP, the LB management device may traverse the VMs corresponding to the VIP and determine whether a ratio of the number of overloaded VMs and the number of the VMs corresponding to the VIP exceeds a second preset value. If it does, the virtual machine management platform may be notified to add a new VM to the VIP, and the LB forwarding device may be notified that a new VM was added to the VIP. This may cause the LB forwarding device to use the scheduling policy of the VIP issued by the LB management device to distribute bearer services to the VMs corresponding to the VIP. If it does not, the LB forwarding device may be notified not to distribute bearer services to the overloaded VMs.

In an example, the method for notifying the LB forwarding device not to distribute bearer services to the overloaded VMs may be implemented based on the scheduling policy. The specific processes for implementing the notification according to two different scheduling policies may be described below.

If the scheduling policy is to carry out the scheduling in accordance with the priority level of the VM, then the priority level of an overloaded VM may be set to the lowest level, and the LB forwarding device may be notified of the setting. The LB forwarding device may distribute bearer services to a VM with higher priority level according to the scheduling policy, and no new service may be dispatched to the overloaded VM.

If the scheduling policy is to poll the VMs, then the LB forwarding device may be notified not to dispatch new services to the overloaded VM when polling.

In an example, when the LB forwarding device configures VMs corresponding to the VIP, it may also configure the maximum number of concurrent connections of a VM and the maximum number of requests of the VM. Further, a third preset value may be configured, which is used to determine whether a VM is overloaded.

When the LB forwarding device reports the status information of the VIP, it may also report the status information of the VM corresponding to the VIP. The status information of the VM may include: a current number of concurrent connections of the VM, a current number of requests per second of the VM, a CPU usage rate of the VM, and a memory usage rate of the VM.

In an example, the method for the LB management device to determine whether a virtual machine is overloaded may be as follows.

1. Determine a ratio of the number of concurrent connections of the VM and a ratio of the number of requests of the VM.

In an example, the ratio of the number of concurrent connections of a virtual machine may be determined based on the current number of concurrent connections of the virtual machine and the maximum number of concurrent connections of the virtual machine. The ratio of the number of requests of the virtual machine may be determined based on the current number of requests per second of the virtual machine and the maximum number of requests of the virtual machine.

2. Determine an overload index of the virtual machine.

In an example, the overload index of the virtual machine may be determined from a weighted sum of the ratio of the number of concurrent connections of the virtual machine, the ratio of the number of requests of the virtual machine, the CPU usage rate of the virtual machine, and the memory usage rate of the virtual machine. The overload index of the VM may be determined according to practical requirements. The weighted calculation may also be carried out using at least one parameter selected from the ratio of the number of concurrent connections of the VM, the ratio of the number of requests of the VM, the CPU usage rate of the VM, and the memory usage rate of the VM. The weight of the parameters that do not require in the weighted calculation may be set as 0. The sum of the weights of the parameters participated in the weighted calculation may be equivalent to 1.

3. Determine whether the overload index of the virtual machine exceeds a third preset value. If it does, the virtual machine is defined as overloaded; if not, the virtual machine is defined as not overloaded.

In an example, a VM may be under a light load or has no load due to initial configuration or a scheduling policy. Whether a VM is under a light load or has no load or not may be determined via the calculated overload index of the VM. If the overload index is below a preset value, a light load or no load situation may exist.

If it is determined that a VM is under a light load or has no load, the LB forwarding device may be notified that the VM is to quit service bearing, which may cause a slow shutdown of the VM. The virtual machine management platform may also be notified to delete the VM following the shutdown of the VM.

FIG. 2(b) shows a flowchart illustrating the interaction process for adjusting virtual machine resources in an example of the present disclosure.

At Block 201, an LB management device may divide virtual services. Each virtual service may be distributed a corresponding VIP. A scheduling policy and VMs may be configured for the VIP. In an example, multiple VMs are configured for each VIP.

At Block 202, the LB management device may issue configured information of each VIP (including a scheduling policy and VMs allocated to the VIP) to an LB forwarding device.

At Block 203, the LB forwarding device reports the status information of each VIP that it detects to the LB management device.

At Block 204, the LB management device determines whether the VIP is overloaded based on the status information of the VIP it receives. If the VIP is overloaded (Y), then Blocks 205-206 are carried out. If the VIP is not overloaded (N), then Blocks 207-211 are carried out.

At Block 205, the LB management device may notify a virtual machine management platform to add a new VM for the overloaded VIP.

At Block 206, the LB management device may inform the LB forwarding device of the VM that was newly added to the overloaded VIP, which causes the LB forwarding device to use the scheduling policy of the VIP to update the distribution of services to the VMs corresponding to the VIP, and then the process is ended. In an example, The LB forwarding device may carry out configuration for the newly added VM, while the configuration of the other VMs remains unchanged. In another example, the LB forwarding device may adjust the configuration of part of or all the VMs corresponding to the VIP.

At Block 207, the LB management device traverses VMs corresponding to a VIP that is not overloaded, and searches for overloaded VMs of the VIP.

At Block 208, the LB management device determines whether a ratio of the number of overloaded VMs and the number of the VMs corresponding to the VIP exceeds a second preset value. If it does (Y), then Blocks 209-210 are carried out; if not (N), then Block 211 is carried out.

At Block 209, the LB management device notifies the virtual machine management platform to add another VM for the VIP.

At Block 210, the LB management device notifies the LB forwarding device that another VM for the VIP is added, which causes the LB forwarding device to use the scheduling policy of the VIP to distribute bearer services to the VMs corresponding to the VIP.

At Block 211, the LB management device notifies the LB forwarding device not to distribute bearer services to an overloaded VM.

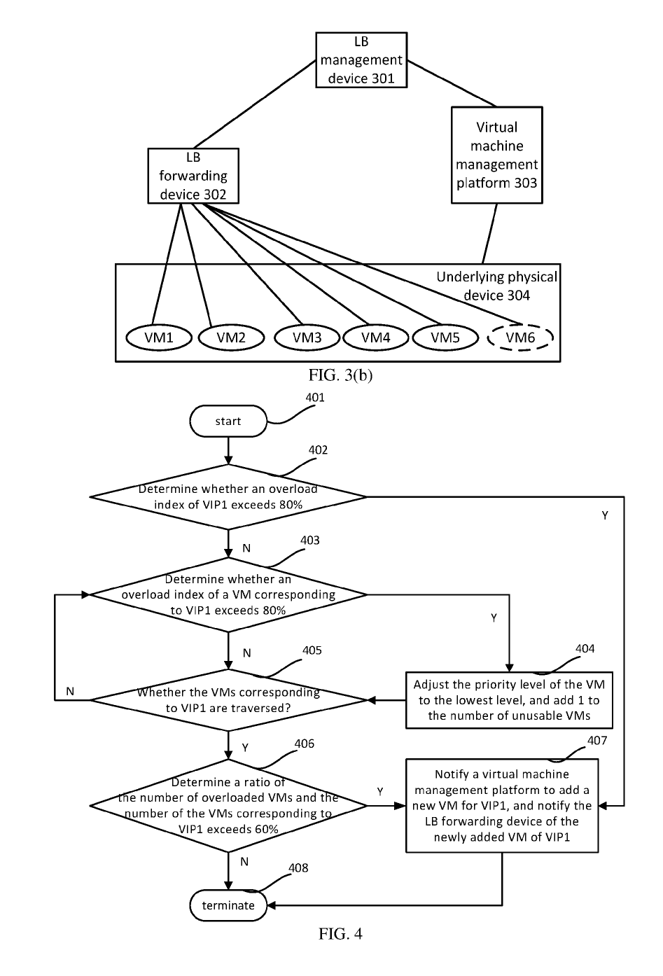

In an example, the adjustment of virtual machine resources may be described in such as FIG. 3(a) or FIG. 3(b). FIG. 3(a) is a schematic diagram depicting an LB system including an LB management device 301 and an LB forwarding device 302.

In the LB system, the LB management device 301 may divide virtual services based on service conditions, allocate corresponding virtual IP addresses (VIP) for the virtual services, configure a scheduling policy and corresponding virtual machines (VM) for each VIP, and issue the configured information to the LB forwarding device. The LB management device 301 may determine that a VIP is overloaded based on status information of the VIP it receives, notify the virtual machine management platform to add a new VM for the VIP, and notify the LB forwarding device that a new VM was added for the VIP.

The LB forwarding device 302 may configure the VIP and the VMs corresponding to the VIP on an underlying physical device based on the configured information issued by the LB management device 301. The LB forwarding device 302 may report the detected status information of each VIP to the LB management device 301. When receiving a notification of a newly added VM, the LB forwarding device 302 may use the scheduling policy of the VIP corresponding to the VM to distribute bearer services to the VMs corresponding to the VIP. For example, the LB forwarding device 302 may distribute a bearer service to the newly added VM according to the scheduling policy of the VIP.

FIG. 3(b) is a diagram depicting the composition of the network communications system in accordance with an example of the present disclosure. In an example, the network communications system includes: an LB management device 301, an LB forwarding device 302, a virtual machine management platform 303, and an underlying physical device 304. The virtual machine management platform 303 may be to add a new VM for a VIP based on a notification from the LB management device 301.

In an example, the LB management device 301 may be a server for managing load balance, which may be accessed through an IP address of the LB management device 301. In the network communications system shown in FIG. 3(b), the underlying physical device 304 may include multiple underlying servers. The underlying physical device 304 may connect to an aggregation switch through multiple access switches, and reach an internet port through the aggregation switch. The LB forwarding device 302 and the aggregation switch may be deployed at the same level in the network communications system. In an example, the LB forwarding device 302 may be a VM server gateway. In an example, the virtual machine management platform 303 may be a server for managing VMs. In an example, the server may be a dedicated computer that provides some kind of service for a client in a network environment.

Prior to application deployment on the system, the LB management device 301 may assign an amount of virtual services based on its own service conditions, and reserve a range of IP addresses for the virtual services for follow-up usage. After the planning is completed, load balancing parameters may be configured for the application through various ways such as API interfaces. The configuration may be considered as a scheduling policy. For example, when configuring VIP1, the first preset value may be 80%, the second preset value may be 60%, and the third preset value may be 80%.

In an example, 5 IP addresses for VIP1, such as IP1 to IP5 may be allocated. That is, 5 virtual machine resources including IP1 through IP5 may be predefined as bearers for VIP1, while IP6 through IP10 may be reserved for VIP1. Simultaneously, the scheduling policy may be configured. The configured information (i.e., VIP (IP1, IP2, . . . , IP5), scheduling policy)) may be transmitted to the underlying physical device 304 through the LB forwarding device 302. VIP1 and VM1 through VMS corresponding to VIP1 may be configured on the underlying physical device 304.

The LB forwarding device 302 may automatically detect application status of VIP1, collect statistics concerning the status information of VIP1 and status information of the virtual machines (VM1 through VMS) that correspond to VIP 1, and report it to the LB management device 301. The status information of the VIP may include: a current flow rate of the VIP, a current number of concurrent connections of the VIP, and a current number of requests per second of the VIP. In an example, the status information of the virtual machine may include: a current number of concurrent connections of the virtual machine, a current number of requests per second of the virtual machine, a CPU usage rate, and a memory usage rate.

In an example, the LB management device 301 may determine whether an overload exists, or determine whether it is necessary to carry out VM adjustment, etc., based on the reported status information of VIP1 and the reported status information of the VMs corresponding to VIP1. Refer to FIG. 4, which is a flow diagram showing the method for determining whether an overload exists on VIP1 in an example of the present disclosure.

At Block 401, the process shown in FIG. 4 may be started.

At Block 402, the LB management device may determine whether an overload index of VIP1 exceeds 80%. If the overload index exceeds 80%, proceed to Block 407; if not, proceed to Block 403. In an example, the detailed method for calculating the overload index of VIP1 may refer to that described on FIGS. 1-3.

At Block 403, the LB management device may determine whether an overload index of a VM corresponding to VIP1 exceeds 80%. If it does, proceed to Block 404; if not, proceed to Block 405. In an example, the detailed method for calculating the overload index of the VM may refer to that described on FIGS. 1-3.

At Block 404, the LB management device may adjust the priority level of the VM to the lowest level, and add 1 to the number of unusable VMs. The priority level may be described herein as an example.

At Block 405, it is determined whether the LB management device may finish polling the VMs corresponding to VIP1. If the polling is finished, proceed to Block 406; if it is not, proceed to Block 403.

At Block 406, the LB management device may determine whether a ratio of the number of overloaded VMs and the number of VMs corresponding to VIP1 exceeds 60%. If it does, proceed to Block 407; if it does not, proceed to Block 408.

At Block 407, the LB management device may notify the virtual machine management platform to add a new VM for VIP1, and notify the LB forwarding device that there is a newly added VM for VIP1.

The newly added VM may use a reserved IP address, such as IP6. The LB management device may distribute bearer services for the VMs corresponding to VIP1 (i.e., VM1 through VM6) based on the scheduling policy for VIP1, which may refer to such as FIG. 2.

At Block 408, the process may be terminated.

In an example, if it is determined that a VM with no load exists, the virtual machine management platform may be notified to delete the corresponding VM. The LB forwarding device may also be notified that VIP1 has deleted the corresponding VM, which causes bearer services to be distributed among the remaining VMs of VIP1 according to the scheduling policy.

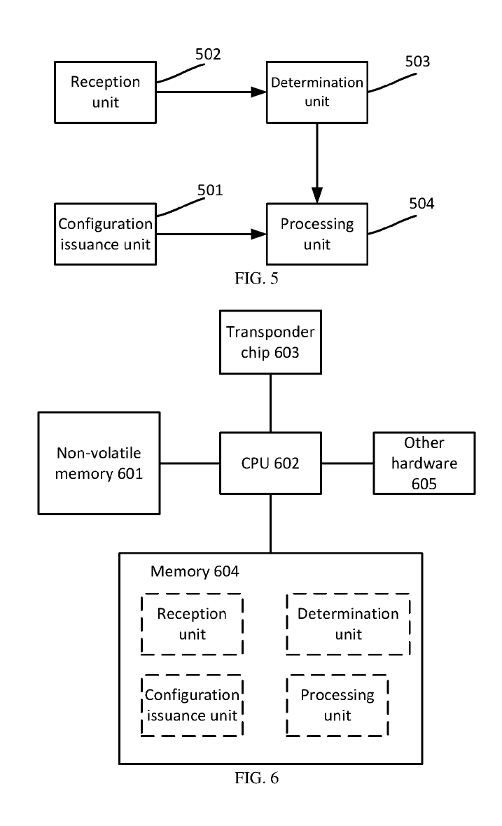

In an example of the present disclosure, a device may be proposed, which may be adopted by an LB management device. In an example, the LB management device may cooperate with an LB forwarding device and a virtual machine management platform to form a system. FIG. 5 illustrates a schematic diagram of the structure of the device according to an example of the present disclosure. The device may include: a configuration issuance unit 501, a reception unit 502, a determination unit 503, and a processing unit 504.

The configuration issuance unit 501 is to divide VIPs based on service conditions, configure a scheduling policy and corresponding VMs for each VIP, and issue it to the LB forwarding device which may cause the LB forwarding device to configure the VIP and the VMs corresponding to the VIP on an underlying physical device.

The reception unit 502 is to receive status information of a VIP reported by the LB forwarding device.

The determination unit 503 is to determine whether the VIP is overloaded based on the status information of the VIP that is received by the reception unit 502 and detected and reported by the LB forwarding device.

The processing unit 504 is to notify the virtual machine management platform to add a new VM for the VIP, and notify the LB forwarding device of the newly added VM when the determination unit 503 determines that the VIP is overloaded. Thereafter, the LB forwarding device may use the scheduling policy of the VIP issued by the configuration issuance unit 501 to distribute bearer services to the VMs corresponding to the VIP.

In an example, the configuration issuance unit 501 is further to allocate reserved IP addresses for a VIP.

The processing unit 504 is further to notify the virtual machine management platform of the IP address of the newly added VM when the virtual machine management platform is notified to add the new VM for the VIP. The IP address may be an IP address that was reserved for the VIP by the configuration issuance unit 501.

In an example, the configuration issuance unit 501 is further to configure the maximum bandwidth, the maximum number of concurrent connections, and the maximum number of requests for the VIP. The status information of the VIP may include: a current flow rate of the VIP, a current number of concurrent connections of the VIP, and a current number of requests per second of the VIP.

In an example, the determination unit 503 is further to determine the ratio of the flow rate of the VIP as the ratio of the current flow rate of the VIP and the maximum bandwidth of the VIP configured by the configuration issuance unit 501.

In an example, the determination unit 503 is further to determine the ratio of the number of concurrent connections of the VIP as the ratio of the current number of concurrent connections of the VIP and the maximum number of concurrent connections of the VIP configured by the configuration issuance unit 501.

In an example, the determination unit 503 is further to determine the ratio of the number of requests of the VIP as the ratio of the current number of requests per second of the VIP and the maximum number of requests of the VIP configured by the configuration issuance unit 501.

In an example, the determination unit 503 is further to obtain an overload index of the VIP as the weighted sum of the ratio of the flow rate, the ratio of the number of concurrent connections, and the ratio of the number of requests of the VIP, and determine whether the overload index of the VIP exceeds a first preset value. If it does, determine that the VIP is overloaded; if it does not, determine that the VIP is not overloaded.

In an example, the reception unit 502 is further to receive the status information of each VM corresponding to the VIP that was reported by the LB forwarding device.

When it is determined that the VIP is not overloaded, the determination unit 503 is further to traverse each VM corresponding to the VIP, and determine whether the ratio of the number of overloaded VMs and the number of the VMs corresponding to the VIP exceeds a second preset value.

When it is determined that the ratio of the number of overloaded VMs and the number of VMs corresponding to the VIP exceeds the second preset value, the processing unit 504 is further to notify the virtual machine management platform to add another VM for the VIP, and notify the LB forwarding device of the newly added VM, which causes the LB forwarding device to use the scheduling policy of the VIP to distribute bearer services to the VMs corresponding to the VIP.

When the determination unit 503 determines that the ratio of the number of the overloaded VMs and the number of the VMs corresponding to the VIP does not exceed the second preset value, notify the LB forwarding device not to distribute bearer services to the overloaded VMs.

In an example, the configuration issuance unit 501 is further to configure the maximum number of concurrent connections of the VM and the maximum number of requests of the VM. The status information of the VM may include: a current number of concurrent connections of the VM, a current number of requests per second of the VM, a CPU usage rate of the VM, and a memory usage rate of the VM.

The determination unit 503 is further to determine the ratio of the number of concurrent connections of the virtual machine as the ratio of the current number of concurrent connections of the virtual machine and the maximum number of concurrent connections of the virtual machine configured by the configuration issuance unit 501.

The determination unit 503 is further to determine the ratio of the number of requests of the virtual machine as the ratio of the current number of requests per second of the virtual machine and the maximum number of requests of the virtual machine configured by the configuration issuance unit 501.

The determination unit 503 is further to obtain an overload index of the virtual machine from a weighted sum of the ratio of the number of concurrent connections, the ratio of the number of requests, the CPU usage rate, and the memory usage rate of the virtual machine, and determine whether the overload index of the virtual machine exceeds a third preset value. If it does, determine that the virtual machine is overloaded; if not, determine that the virtual machine is not overloaded.

The above mentioned units in the example may be integrated into a single device and may also be deployed separately. They may be merged into a unit or may be further split into multiple units.

The device illustrated in FIG. 5 may be a programmable device with integrated software and hardware. FIG. 6 is a schematic diagram illustrating the hardware framework of the device of FIG. 5 according to an example of the present disclosure. In an example, the device may include: a non-volatile memory 601, a central processor (CPU) 602, a transponder chip 603, a memory 604 and other hardware 605. The memory 604 and the non-volatile memory 601 are example non-transitory machine readable storage media.

The memory 604 is to store command codes, such as machine readable instructions. In an example, the command codes may be set to execute the functions of the reception unit, the determination unit, the configuration issuance unit, and the processing unit, which may refer to FIGS. 1-5.

The CPU 602 communicates with the transponder chip 603 for sending and receiving notifications and status information. In an example, the CPU 602 may receive status information from the LB forwarding device, issue configuration contents to the LB forwarding device, notify the LB forwarding device of newly added VMs or deleted VMs, and notify the virtual machine management platform of information concerning newly added VMs. In an example, the CPU 602 may communicate with a memory, read and execute command codes stored in the memory, and realize the functions of the reception unit, the determination unit, the configuration issuance unit, and the processing unit, etc. In an example, the CPU 602 may process the status information sent from the transponder chip 603, communicate with the non-volatile memory 601, and read/write data (such as the configured information of the VIP) in the non-volatile memory 601.

In an example, the configuration issuance unit is to allocate VIPs based on service conditions, configure a scheduling policy and corresponding VMs for each VIP, and send the configuration contents to the LB forwarding device through the transponder chip 603. Then, the LB forwarding device may configure the VIP and the VMs corresponding to the VIP on the underlying physical device.

The reception unit is to receive status information from the transponder chip 603 that comes from the LB forwarding device, and save the status information to the non-volatile memory 601.

The determination unit is to determine whether a VIP is overloaded, whether a VM corresponding to the VIP is overloaded, and the number of overloaded VMs corresponding to a certain VIP, etc., after the reception unit receives status information of the VIP and status information of the VM from the transponder chip 603 reported by the LB forwarding device, and send determination results to the processing unit.

The processing unit is to carry out processing based on the determination results provided by the determination unit. When the determination results indicate overload, a notification for the virtual machine management platform as well as a notification for the LB forwarding device are sent to the transponder chip 603.

The transponder chip 603 may connect to the LB forwarding device and the virtual machine management platform through a port on the transponder chip 603. The transponder chip 603 may be responsible for sending and receiving notifications and information. In an example, the transponder chip 603 may send the notifications or configured information received from the CPU 602 to the LB forwarding device, send the notifications from the CPU 602 to the virtual machine management platform, and send status information received from the LB forwarding device to the CPU 602.

The non-volatile memory 601 is to store data, including: status information reported from the LB forwarding device, configured information of each VIP issued by the configuration issuance unit, etc.

FIG. 6 depicts an example of the device, which can also be implemented through another structure different from that described in FIG. 6. For example, the operations may be completed using a certain application-specific integrated circuit (ASIC). In an example, there may be one or more of the aforementioned CPU. If there are multiple CPUs, then reading and executing the aforementioned command codes may be the joint responsibility of the multiple CPUs.

In an example, the LB management device may receive status information of each VIP that is detected and reported by the LB forwarding device. When it is determined that the VIP is overloaded based on the status information of the VIP, the virtual machine management platform is notified to add a new VM for the VIP. The LB forwarding device may be notified of the newly added VM for the VIP, which causes the LB forwarding device to use the scheduling policy of the VIP issued by the LB management device to distribute bearer services to the VMs corresponding to the VIP. In this way, dynamic adjustment of virtual machine resources may automatically be implemented, thereby reducing the operation and maintenance workload.

The above examples can be implemented by hardware, software or firmware or a combination thereof. For example, the various methods, processes and functional modules described herein may be implemented by a processor (the term processor is to be interpreted broadly to include a CPU, processing unit, ASIC, logic unit, or programmable gate array etc.). The processes, methods and functional modules may all be performed by a single processor or split between several processors; reference in this disclosure or the claims to a ‘processor’ should thus be interpreted to mean ‘one or more processors’. The processes, methods and functional modules be implemented as machine readable instructions executable by one or more processors, hardware logic circuitry of the one or more processors or a combination thereof. Further the teachings herein may be implemented in the form of a software product. The computer software product is stored in a non-transitory storage medium and comprises a plurality of instructions for making a computing device (which can be a personal computer, a server or a network device such as a router, switch, access point, load balancing forwarding device, load balancing management device etc.) implement the method recited in the examples of the present disclosure.

The figures are only illustrations of an example, wherein the modules or procedure shown in the figures are not necessarily essential for implementing the present disclosure. The modules in the aforesaid examples can be combined into one module or further divided into a plurality of sub-modules.

What is claimed is:

1. A method for adjusting virtual machine resources, comprising:
distributing a virtual IP address (VIP) for a virtual service, and configuring a scheduling policy and virtual machines (VM) for the VIP;
configuring the VIP and the VMs corresponding to the VIP on an underlying physical device; and
when status information of the VIP is received, adding a new VM into the VMs corresponding to the VIP in response to the determination that the VIP is overloaded based on the status information of the VIP, and using the scheduling policy of the VIP to distribute bearer services to the VMs corresponding to the VIP.

2. The method according to claim 1, further comprising:
allocating a reserved IP address for the VIP; and
notifying a virtual machine management platform the reserved IP address for the VIP as an IP address of the newly added VM.

3. The method according to claim 1, wherein the status information of the VIP comprises: a current flow rate of the VIP, a current number of concurrent connections of the VIP, and a current number of requests per second of the VIP; and
wherein the determination that the VIP is overloaded comprises:
configuring the maximum bandwidth of the VIP, the maximum number of concurrent connections of the VIP, and the maximum number of requests of the VIP;
determining a ratio of the flow rate of the VIP based on the current flow rate of the VIP and the maximum bandwidth of the VIP;
determining a ratio of the number of concurrent connections of the VIP based on the current number of concurrent connections of the VIP and the maximum number of concurrent connections of the VIP;
determining a ratio of the number of requests of the VIP based on the current number of requests per second of the VIP and the maximum number of requests of the VIP;
obtaining an overload index of the VIP from a weighted sum of the ratio of the flow rate of the VIP, the ratio of the number of concurrent connections of the VIP, and the ratio of the number of requests of the VIP; and
determining that the VIP is overloaded when the overload index of the VIP exceeds a first preset value.

4. The method according to claim 1, further comprising:
when it is determined that the VIP is not overloaded based on the status information of the VIP, traversing the VMs corresponding to the VIP to determine whether a VM among the VMs of the VIP is overloaded;
determining whether a ratio of the number of overloaded VMs and the number of VMs corresponding to the VIP exceeds a second preset value;
when the ratio exceeds the second preset value, notifying a virtual machine management platform to add a new VM for the VIP, and notifying an LB forwarding device of the newly added VM for the VIP, enabling the LB forwarding device to use the scheduling policy of the VIP to distribute the bearer services to the newly added VM; and
when the ratio does not exceed the second preset value, notifying the LB forwarding device not to distribute the bearer services to the overloaded VMs.

5. The method according to claim 4, further comprising: receiving status information of the VMs corresponding to the VIP reported by the LB forwarding device;
wherein the status information of the VM comprises: a current number of concurrent connections of the VM, a current number of requests per second of the VM, a CPU usage rate of the VM, and a memory usage rate of the VM; and
determining whether the VM is overloaded comprises:
configuring the maximum number of concurrent connections of the VM and the maximum number of requests of the VM;
determining a ratio of the number of concurrent connections of the VM based on the current number of concurrent connections of the VM and the maximum number of concurrent connections of the VM;
determining a ratio of the number of requests of the VM based on the current number of requests per second of the VM and the maximum number of requests of the VM;
obtaining an overload index of the VM from a weighted sum of the ratio of the number of concurrent connections of the VM, the ratio of the number of requests of the VM, the CPU usage rate of the VM, and the memory usage rate of the VM; and
determining that the VM is overloaded when the overload index of the VM exceeds a third preset value.

6. A load balancing (LB) management device, comprising:
a processor;
a non-transitory machine readable storage medium; and
program units stored in the non-transitory machine readable storage medium and executable by the processor, the program units include:
a configuration issuance unit, a reception unit, a determination unit, and a processing unit;
the configuration issuance unit is to divide virtual services based on service conditions, distribute a corresponding virtual IP address (VIP) for a virtual service, configure a scheduling policy as well as corresponding virtual machines (VM) for the VIP and issue the configured information to an LB forwarding device, to enable the LB forwarding device to configure the VIP and the VMs corresponding to the VIP on an underlying physical device;
the reception unit is to receive status information of the VIP reported by the LB forwarding device;
the determination unit is to determine whether the VIP is overloaded based on the status information of the VIP; and
the processing unit is to notify a virtual machine management platform to add a new VM for the VIP, and notify the LB forwarding device of the newly added VM for the VIP when the determination unit determines that the VIP is overloaded, enabling the LB forwarding device to use the scheduling policy of the VIP issued by the configuration issuance unit to distribute bearer services to the VMs corresponding to the VIP.

7. The LB management device according to claim 6, wherein the configuration issuance unit is further to allocate reserved IP addresses for the VIP; and
the processing unit is further to notify the virtual machine management platform of an IP address of the newly added VM, wherein the IP address is a reserved IP address for the VIP allocated by the configuration issuance unit.

8. The LB management device according to claim 6, wherein the status information of the VIP comprises: a current flow rate of the VIP, a current number of concurrent connections of the VIP, and a current number of requests per second of the VIP; and
the configuration issuance unit is further to configure the maximum bandwidth of the VIP, the maximum number of concurrent connections of the VIP, and the maximum number of requests of the VIP;
the determination unit is to:
determine a ratio of the flow rate of the VIP based on the current flow rate of the VIP and the maximum bandwidth of the VIP;
determine a ratio of the number of concurrent connections of the VIP based on the current number of concurrent connections of the VIP and the maximum number of concurrent connections of the VIP;
determine a ratio of the number of requests of the VIP based on the current number of requests per second of the VIP and the maximum number of requests of the VIP;
obtain an overload index of the VIP from a weighted sum of the ratio of the flow rate of the VIP, the ratio of the number of concurrent connections of the VIP, and the ratio of the number of requests of the VIP;
determine whether the overload index of the VIP exceeds a first preset value; and
if the overload index of the VIP does, determine that the VIP is overloaded; if the overload index of the VIP does not, determine that the VIP is not overloaded.

9. The LB management device according to claim 6, wherein the reception unit is further to receive status information of the VMs corresponding to the VIP reported by the LB forwarding device;
the determination unit is further to traverse the VMs corresponding to the VIP when the VIP is not overloaded, and determine whether a ratio of the number of overloaded VMs and the number of the VMs corresponding to the VIP exceeds a second preset value;
the processing unit is further to: notify the virtual machine management platform to add a new VM for the VIP, notify the LB forwarding device of the newly added VM for the VIP when it is determined that the ratio of the number of the overloaded VMs and the number of the VMs corresponding to the VIP exceeds the second preset value, and enable the LB forwarding device to use the scheduling policy of the VIP sent from the LB management device to distribute the bearer services to the VMs corresponding to the VIP; and
the processing unit is further to: notify the LB forwarding device not to distribute the bearer services to the overloaded VMs when it is determined by the determination unit that the ratio of the number of the overloaded VMs and the number of the VMs corresponding to the VIP does not exceed the second preset value.

10. The LB management device according to claim 9, wherein the status information of the VM comprises: a current number of concurrent connections of the VM, a current number of requests per second of the VM, a CPU usage rate of the VM, and a memory usage rate of the VM; and
the configuration issuance unit is further to configure the maximum number of concurrent connections of the VM and the maximum number of requests of the VM;
the determination unit is further to:
determine a ratio of the number of concurrent connections of the VM based on the current number of concurrent connections of the VM and the maximum number of concurrent connections of the VM;
determine a ratio of the number of requests of the VM based on the current number of requests per second of the VM and the maximum number of requests of the VM;
obtain an overload index of the VM from a weighted sum of the ratio of the number of concurrent connections of the VM, the ratio of the number of requests of the VM, the CPU usage rate of the VM, and the memory usage rate of the VM;
determine whether the overload index of the VM exceeds a third preset value; and
if the overload index of the VM does, determine that the VM is overloaded; if the overload index of the VM does not, determine that the VM is not overloaded.

11. A load balancing (LB) system, comprising:
an LB management device, to divide virtual services and allocate virtual IP addresses (VIP) for the virtual services, configure a scheduling policy and corresponding virtual machines (VM) for a VIP, and send the configured information to an LB forwarding device, when it is determined that the VIP is overloaded based on status information of the VIP, notify a virtual machine management platform to add a VM for the VIP, and notify the LB forwarding device of the newly added VM for the VIP;
the LB forwarding device, to configure on an underlying physical device the VIP and the VMs corresponding to the VIP based on the configured information, and report the status information of the VIP to the LB management device, use the scheduling policy of the VIP corresponding to the newly added VM to distribute bearer services to the newly added VM.

12. The LB system according to claim 11, wherein the LB management device is further to:
reserve an IP address for the VIP, and notify a virtual machine management platform of the reserved IP address for the VIP as the IP address of the newly added VM when the virtual machine management platform is notified to add the new VM for the VIP.

13. The LB system according to claim 11, wherein the LB management device is further to:
configure the maximum bandwidth of the VIP, the maximum number of concurrent connections of the VIP, and the maximum number of requests of the VIP;
determine a ratio of flow rate of the VIP based on a current flow rate of the VIP and the maximum bandwidth of the VIP;
determine a ratio of number of concurrent connections of the VIP based on a current number of concurrent connections of the VIP and the maximum number of concurrent connections of the VIP;
determine a ratio of number of requests of the VIP based on a current number of requests per second of the VIP and the maximum number of requests of the VIP;
obtain an overload index of the VIP from a weighted sum of the ratio of the flow rate of the VIP, the ratio of the number of concurrent connections of the VIP, and the ratio of the number of requests of the VIP;
determine whether the overload index of the VIP exceeds a first preset value; and
if the overload index of the VIP does, determine that the VIP is overloaded, and if the overload index of the VIP does not, determine that the VIP is not overloaded.

14. The LB system according to claim 11, wherein the LB management device is further to:
traverse the VMs corresponding to the VIP when it is determined that the VIP is not overloaded;
determine whether a ratio of the number of overloaded VMs and the number of the VMs corresponding to the VIP exceeds a second preset value;
when it is determined that the ratio of the number of the overloaded VMs and the number of the VMs corresponding to the VIP exceeds the second preset value, notify the virtual machine management platform to add a new VM for the VIP, and notify the LB forwarding device that there is a newly added VM for the VIP, and when it is determined that the ratio of the number of the overloaded VMs and the number of the VMs corresponding to the VIP does not exceed the second preset value, notify the LB forwarding device not to distribute the bearer services to the overloaded VMs; and
the LB forwarding device is further to use the scheduling policy of the VIP sent from the LB management device to distribute the bearer services to the newly added VM when there is the newly added VM for the VIP.

15. The LB system according to claim 14, wherein the LB management device is further to:
receive status information of the VMs corresponding to the VIP from the LB forwarding device, wherein the status information of the VM comprises: a current number of concurrent connections of the VM, a current number of requests per second of the VM, a CPU usage rate of the VM, and a memory usage rate of the VM;
configure the maximum number of concurrent connections of the VM, and the maximum number of requests of the VM;
determine a ratio of the number of concurrent connections of the VM based on the current number of concurrent connections of the VM and the maximum number of concurrent connections of the VM;
determine a ratio of the number of requests of the VM based on the current number of requests per second of the VM and the maximum number of requests of the VM;
obtain an overload index of the VM from a weighted sum of the ratio of the number of concurrent connections of the VM, the ratio of the number of requests of the VM, the CPU usage rate of the VM, and the memory usage rate of the VM;
determine whether the overload index of the VM exceeds a third preset value; and
if the overload index of the VM does, determine that the VM is overloaded; if the overload index of the VM does not, determine that the VM is not overloaded.
